(19) United States
(12) Patent Application Publication
(10) Pub. No.: US 2013/0049554 A1
(43) Pub. Date: Feb. 28, 2013

(54) DIFFERENTIAL RACK AND PINION STORAGE MEDIA MOVER ASSEMBLY

(71) Applicant: Christian A. TODD, Parker, CO (US)

(72) Inventor: Christian A. TODD, Parker, CO (US)

(73) Assignee: QUALTUM CORPORATION

(21) Appl. No.: 13/222,685

(22) Filed: Aug. 31, 2011

(51) Int. Cl. A47B 81/06; F16H 19/04; A47B 96/00

(52) U.S. Cl. 312/9.1; 211/49.1; 74/422

(57) ABSTRACT

A combination comprises a first rack (314A), a second rack (314B) and a mover (218). The second rack (314B) is positioned substantially adjacent to the first rack (314A). The mover (218) includes a first rack gear (254), a second rack gear (256) and a differential adjuster (258). The first rack gear (254) moves along and between the first rack (314A) and the second rack (314B). The second rack gear (256) moves along and between the first rack (314A) and the second rack (314B). The differential adjuster (258) enables the first rack gear (254) and the second rack gear (256) to selectively rotate independently of one another. The first rack (314A) can be spaced apart from the second rack (314B) by a rack joint gap (368). While one of the rack gears (254, 256) is positioned adjacent to the rack joint gap (368), the first rack gear (254) and the second rack gear (256) can rotate independently of one another. The mover (218) can further include a first pinion gear (250) and a second pinion gear (252) that are mounted on the differential adjuster (258). The differential adjuster (258) enables the first pinion gear (250) and the second pinion gear (252) to selectively rotate independently of one another while maintaining smooth motion.

### BACKGROUND

Magnetic tape has long been used as a storage media for audio, video and computer information. Magnetic tape cartridges have been used extensively because they provide a convenient way to house and support a length of magnetic tape for engagement by a transducer in a tape drive while protecting the tape upon removal of the cartridge. Moreover, magnetic tape cartridges facilitate economic and compact storage of data. With the advent of widespread use of magnetic tape cartridges, the need to provide systems for storage and retrieval of such tape cartridges has resulted in a wide range of automated systems.

Typically, a plurality of tape cartridges are stored within a storage library, with each tape cartridge being stored in a particular slot in the storage library and each slot being identifiable by its physical position in the storage library. Additionally, each tape cartridge is typically uniquely identified by a machine readable label such that the storage library can maintain inventory information to associate a particular tape cartridge with a particular slot in the storage library. To manage such a vast amount of information, a central cartridge inventory can be maintained by a library controller within the library, so that logical requests for a particular drive and cartridge may be translated by the library controller into physical device locations and electromechanical operations, for example. Responsive to a host computer request, a robotic mechanism moves along a rack to physically retrieve an appropriate tape cartridge from its associated slot in the storage library, move the tape cartridge to an appropriate device, i.e. a tape drive, and insert the tape cartridge into the device so that the requested read/write operations can be performed.

Automated tape libraries (ATLs) have been developed to expedite the selection and loading of magnetic tape cartridges. Using such ATLs periodically requires capacity expansion to accommodate additional media. Several approaches have been proposed to accommodate such capacity expansion. For example, a smaller library can be replaced by a larger library, an additional stand-alone library can be added, and/or a larger library than currently necessary can be purchased, with certain cartridge locations being disabled until needed. Unfortunately, each of these potential solutions has certain drawbacks, including various cost, size, storage space, and logistical issues that may be associated with each potential solution.

Accordingly, in the field of ATLs there is a specific segment of the market that has recently turned to the solution of having the storage libraries themselves being expandable. In such ATLs, a single robotic mechanism can move through the entire library eliminating the need to provide a separate mechanism for moving cartridges between libraries. This approach also simplifies the requirements for control software and library management, and may also reduce the cost of storage library systems. One way of accomplishing this library expansion is to stack the individual library segments on top of or beside one another and link or align rack segments together. Unfortunately, this usually requires aligning each subsequent rack segment to the preceding rack segment(s), which often requires the use of specialty tools to ensure that the rack segments are joined together with the necessary precision. Moreover, it can be extremely difficult to achieve accurate and precise positioning of adjacent rack segments to ensure a seamless transition during movement of the robotic mechanism from one rack segment to another. Another potential manner of accomplishing library expansion would be to design libraries on an optimized rack pitch. However, tolerance stack-ups and nominal clearances can make this type of a solution difficult if not impractical.

### SUMMARY

The present invention is directed toward a combination comprising a first rack, a second rack and a mover. The second rack is positioned substantially adjacent to the first rack. The mover includes a first rack gear, a second rack gear and a differential adjuster. The first rack gear moves along and between the first rack and the second rack. Somewhat similarly, the second rack gear moves along and between the first rack and the second rack. The differential adjuster enables the first rack gear and the second rack gear to selectively rotate independently of one another.

In one embodiment, the first rack has a plurality of first rack teeth and the second rack has a plurality of second rack teeth. In such embodiment, the rack gears each engage the first rack teeth and the second rack teeth.

Additionally, in certain embodiments, the first rack is spaced apart from the second rack by a rack joint gap. In such embodiments, while one of the rack gears is positioned adjacent to or in the rack joint gap, the first rack gear and the second rack gear can rotate independently of one another. Further, the first rack can include a plurality of first rack teeth and the second rack can include a plurality of second rack teeth. In one such embodiment, the first rack teeth have a first pitch and the rack joint gap defines a joint pitch that is different than the first pitch. Moreover, in one embodiment, the second rack teeth have a second pitch, and the joint pitch is different than the second pitch. Still further, in one embodiment, the second pitch can be substantially equal to the first pitch. In such embodiment, when the first rack gear moves along the first rack and the second rack gear moves the second rack, the first rack gear rotates at a first speed and the second rack gear rotates at a second speed that is substantially equal to the first speed.

In some embodiments, the mover further includes a first pinion gear and a second pinion gear. The first pinion gear is mounted on the differential adjuster. Additionally, the first pinion gear is positioned to engage the first rack gear. The second pinion gear is also mounted on the differential adjuster. Further, the second pinion gear is positioned to engage the second rack gear. Moreover, in one embodiment, the differential adjuster enables the first pinion gear and the second pinion gear to selectively rotate independently of one another.

In certain embodiments, the mover further includes a drive shaft that is coupled to the differential adjuster. In one such embodiment, the drive shaft moves the differential adjuster and the pinion gears such that the pinion gears rotate at substantially the same speed. Additionally and/or alternatively, the drive shaft can move the differential adjuster and the pinion gears such that the pinion gears rotate at different speeds.

In one embodiment, the combination further comprises a mover motor that rotates the pinion gears to move the mover along and between the first rack and the second rack.

Additionally, the present invention is further directed to a media library including a first library housing, a second library housing that is positioned substantially adjacent to the first library housing, and the combination as described above. Further, the first rack can be positioned within the first library housing and the second rack can be positioned within the second library housing. In one embodiment, the media library further includes a tape cartridge. In such embodiment, the mover moves the tape cartridge between the first library housing and the second library housing.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified block diagram of one embodiment of a media library, including a storage media mover having features of the present invention;

FIG. 2 is a simplified top view of a rack and a portion of an embodiment of the storage media mover; and

FIGS. 3A-3E are simplified partially cutaway front views of an embodiment of the first rack and the second rack, and the portion of the storage media mover illustrated in FIG. 2 as the storage media mover moves gradually from the first rack to the second rack.

### DESCRIPTION

Reference will now be made in detail to various embodiments of the subject matter, examples of which are illustrated in the accompanying drawings. While the subject matter discussed herein will be described in conjunction with various embodiments, it will be understood that they are not intended to limit the described subject matter to these embodiments. On the contrary, the presented embodiments of the invention are intended to cover alternatives, modifications and equivalents that may be included within the spirit and scope of the various embodiments as defined by the appended claims. For example, although the present invention is described in relation to use within a media library, the present invention is equally applicable in other types of systems or devices that utilize rotational movement to generate translational movement. Furthermore, in the following description of embodiments, numerous specific details are set forth in order to provide a thorough understanding of embodiments of the subject matter. However, embodiments may be practiced without these specific details. In other instances, well known methods, procedures, components, and circuits have not been described in detail as not to unnecessarily obscure aspects of the described embodiments.

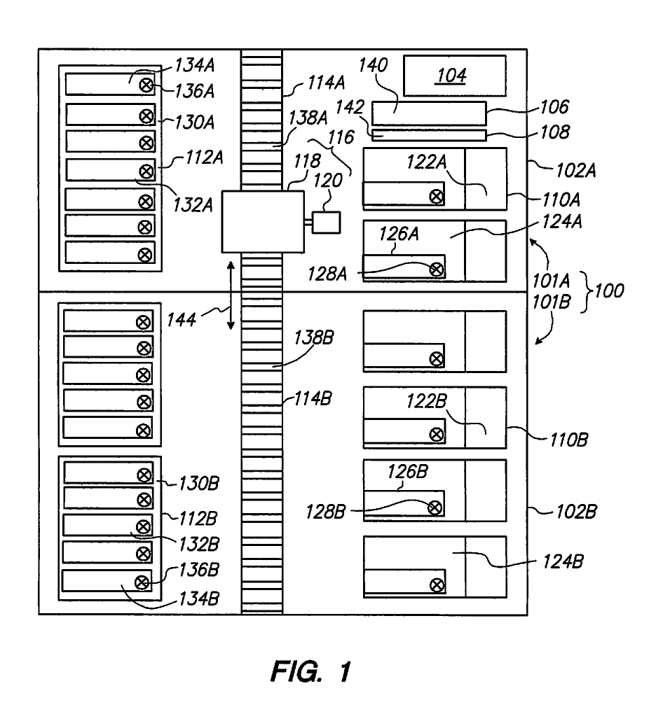

FIG. 1 is a simplified block diagram of an embodiment of a media library 100 including a plurality of library segments, e.g., a first library segment 101A and a second library segment 101B that are secured together and/or are positioned substantially adjacent to one another. In different embodiments, the second library segment 101B can be positioned substantially vertically beneath the first library segment 101A (as illustrated in FIG. 1), substantially vertically above the first library segment 101A, substantially horizontally adjacent to the first library segment 101A, or in another positional relationship relative to the first library segment 101A. Alternatively, the media library 100 can include more than two library segments.

It should be noted that although the media library 100 shown and described relative to FIG. 1 is specifically referred to and described at times as a tape cartridge library or tape library, it is understood that the present invention is equally applicable for use with any other suitable types of libraries using other types of storage media, such as optical disks, magnetic disk drives, emulated tape drives, etc., as non-exclusive examples. However, for ease of discussion, FIG. 1 and various other Figures herein are sometimes described using tape cartridges as the applicable storage media, although this is not intended to restrict or limit the present invention in this manner.

The design of the media library 100 and/or each of the library segments 101A, 101B can be varied. As illustrated in FIG. 1, the media library 100 can include the first library segment 101A having a first housing 102A, a power supply 104, a storage media loader controller slot 106, a library controller slot 108, one or more first data transfer assembly slots 110A, one or more first storage media retainer slots 112A (one is illustrated in FIG. 1), and a first rack 114A. Additionally, in this embodiment, the second library segment 101B includes a second housing 102B, one or more second data transfer assembly slots 110B, one or more second storage media retainer slots 112B, and a second rack 114B. The media library 100 further includes a storage media mover assembly 116 (also sometimes referred to herein simply as a “mover assembly”) having a storage media mover 118 (also sometimes referred to herein simply as a “mover”) that moves along and between the first rack 114A and the second rack 114B, and a mover motor 120.

In alternative embodiments, the first library segment 101A can have any suitable number of first data transfer assembly slots 110A, and/or the first library segment 101A can have any suitable number of first storage media retainer slots 112A, which may differ from that shown in FIG. 1. For example, the first library segment 101A can be designed without any first data transfer assembly slots 110A and/or without any first storage media retainer slots 112A. Somewhat similarly, the second library segment 101B can have any suitable number of second data transfer assembly slots 1108, and/or the second library segment 101B can have any suitable number of second storage media retainer slots 112A, which may differ from that shown in FIG. 1. For example, the second library segment 101B can be designed without any second data transfer assembly slots 110B and/or without any second storage media retainer slots 1128. Additionally and/or alternatively, the power supply 104, the storage media loader controller slot 106 and the library controller slot 108 can be included within the second library segment 101B rather than the first library segment 101A.

It should be noted that the use of the terms “first library segment” and “second library segment” is merely for ease of illustration and description, and either library segment can be considered as the first library segment and/or the second library segment.

As an overview, the mover assembly 116 enables the mover 118 to easily and/or smoothly move translationally along and between the first rack 114A and the second rack 1146 while allowing for some variation in the specifications of the racks 114A, 114B and/or in the positioning of the first rack 114A relative to the second rack 114B. More particularly, and as set forth in greater detail below, the mover 118 adjusts its position to compensate for certain differences in specifications between the first rack 114A and the second rack 1148. Additionally, the mover 118 adjusts to compensate for certain misalignment between the first rack 114A and the second rack 114B. With this design, the first rack 114A and the second rack 114B can have somewhat different specifications, e.g., tooth form, etc., and precise alignment between the first rack 114A and the second rack 114B is not required for smooth and proper functioning of the media library 100.

It is recognized that although the mover assembly 116 illustrated and described herein is specifically shown as part of the media library 100, it is understood that the present invention is equally applicable for use with other suitable types of devices and/or in other suitable industries where a mover may be required to move along and between a first rack to a second rack. However, the application of the present mover assembly 116 as illustrated and described herein as part of the media library 100 is merely for ease of discussion, and such application is not intended to restrict or limit the present invention in any manner.

The first housing 102A, the one or more first data transfer assembly slots 110A, the one or more first storage media retainer slots 112A, and the first rack 114A of the first library segment 101A are substantially similar in design and function to the second housing 102B, the one or more second data transfer assembly slots 1108, the one or more second storage media retainer slots 112B, and the second rack 114B of the second library segment 101B, respectively. Accordingly, the housings 102A, 102B, the one or more data transfer assembly slots 110A, 110B, the one or more storage media retainer slots 112A, 112B and the racks 114A, 114B will be described together.

As illustrated, each of the housings 102A, 102B may be substantially rectangular or square in cross section. Alternatively, one or both of the housings 102A, 102B can have another suitable shape or configuration. For example, one or more of the housing 102A, 102B can have a substantially circular cross-sectional shape. Additionally, each of the housings 102A, 102B may be constructed of any number of conventional materials such as, for example, those utilized in industry standard rack mount cabinets.

In one embodiment, each of the data transfer assembly slots 110A, 110B receives a data transfer assembly 122A, 122B. Further, as provided herein, each data transfer assembly 122A, 122B can include a data transfer device 124A, 124B, such as a standard tape drive, e.g., Quantum DLT 2000XT™, DLT4000™, DLT7000™, DLT8000™, DLT VS80™, DLT VS160™, SDLT 320™, SDLT 600™, LTO-2™, LTO-2 HH™, LTO-3™, or equivalent, as non-exclusive examples. Hereinafter, data transfer device and tape drive are used interchangeably (shown by reference number 124A, 124B in the drawings), and it is to be understood that the data transfer device 124A, 124B described herein can include other suitable devices adapted for use with different types of storage media, such as optical drives, etc.

The data transfer assemblies 122A within the first library segment 101A can be substantially identical to one another. Alternatively, one or more of the data transfer assemblies 122A within the first library segment 101A can be different from the remaining data transfer assemblies 122A in the first library segment 101A. Somewhat similarly, the data transfer assemblies 122B within the second library segment 101B can be substantially identical to one another. Alternatively, one or more of the data transfer assemblies 122B within the second library segment 101B can be different from the remaining data transfer assemblies 122B in the second library segment 101B. Additionally, the data transfer assemblies 122A within the first library segment 101A can be substantially identical to or different from the data transfer assemblies 122B within the second library segment 101B.

Each tape drive 124A, 124B includes a storage media slot 126A, 126B and a corresponding storage media sensor 128A, 128B positioned within the storage media slot 126A, 126B which generates a storage media presence signal. This signal from one tape drive 124A, 124B can be provided to another tape drive in the first library segment 101A, the second library segment 101B or in a different library segment.

Each of the storage media retainer slots 112A, 112B can receive a standard storage media retainer 130A, 130B, which includes a plurality of storage media slots 132A, 132B. For example, each storage media retainer 130A can include seven storage media slots 132A, such as illustrated in the first library segment 101A in FIG. 1, each storage media retainer 130B can include five storage media slots 132B, such as illustrated in the second library segment 101B in FIG. 1, or each storage media retainer 130A, 130B can include another suitable number of storage media slots 132A, 132B. Each storage media slot 132A, 132B can receive a storage media cartridge 134A, 134B (sometimes referred to herein simply as “storage media”), with each of the storage media cartridges 134A, 134B being adapted for use in the media library 100. The storage media retainer 130A, 130B includes a storage media presence flag 136A, 136B within each storage media slot 132A, 132B which provides an indication of the presence or absence of a storage media cartridge 134A, 134B.

In one embodiment, one or both of the racks 114A, 114B can extend substantially from one side of the library segment 101A, 101B to the other. Alternatively, one or both of the racks 114A, 114B can extend only partially between two opposing sides of the corresponding library segment 101A, 101B. Further, each of the racks 114A, 114B can be positioned between the one or more data transfer assembly slots 110A, 110B and the one or more storage media retainer slots 112A, 112B.

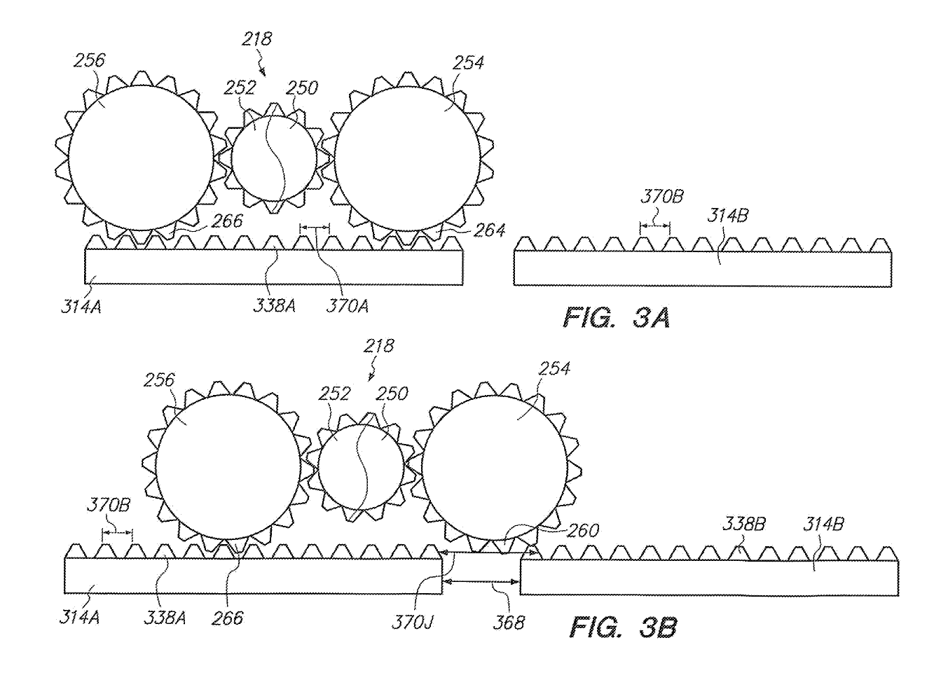

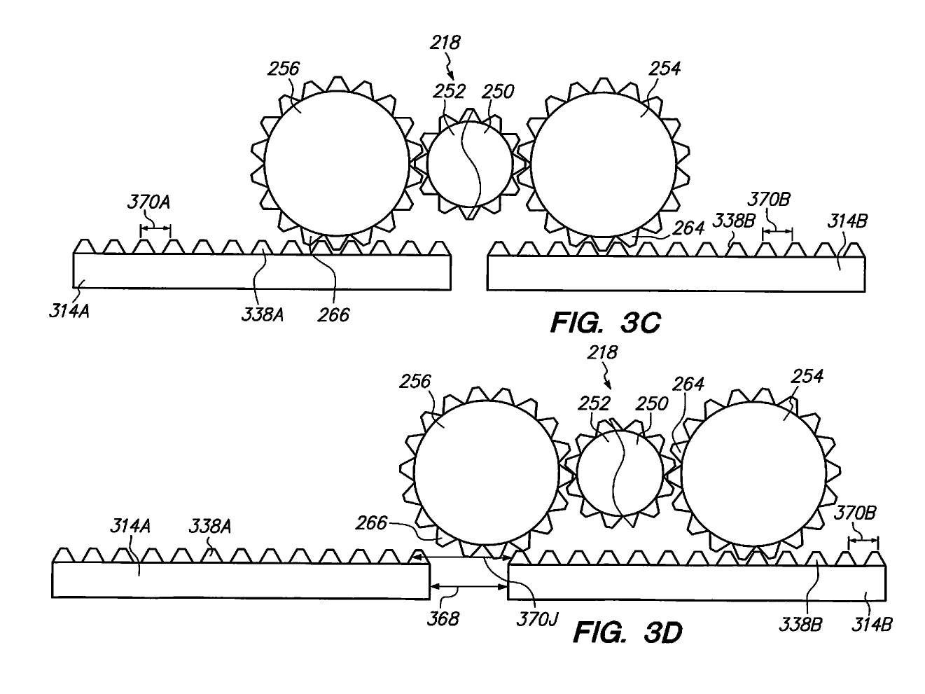

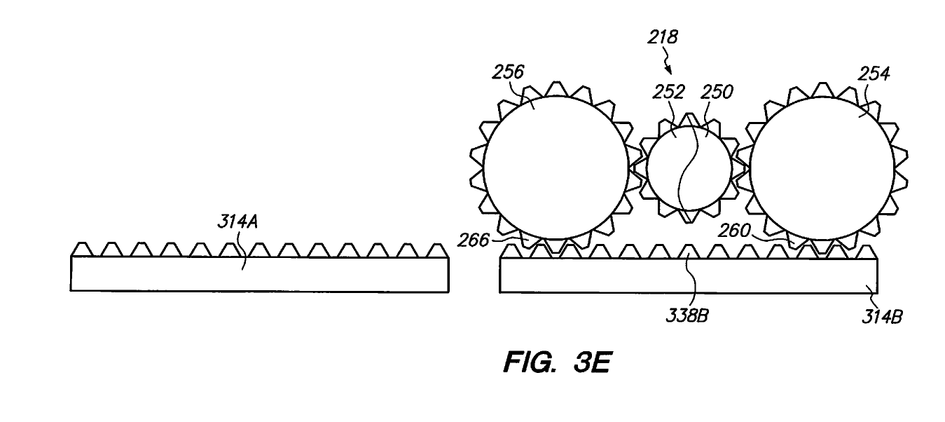

Additionally, each of the racks 114A, 114B includes a plurality of rack teeth, i.e. the first rack 114A includes a plurality of first rack teeth 138A and the second rack 114B includes a plurality of second rack teeth 138B. The first rack teeth 138A and the second rack teeth 138B can individually or concurrently engage a portion of the storage media mover 118 to enable the storage media mover 118 to move smoothly and/or controllably along the racks 114A, 114B. The first rack teeth 138A of the first rack 114A have a first set of specifications, including, for example, a first pitch 370A (illustrated in FIG. 3C), and the second rack teeth 138B of the second rack 114B have a second set of specifications, including, for example, a second pitch 370B (illustrated in FIG. 3C). In certain alternative embodiments, the first set of specifications can be substantially identical to the second set of specifications or the first set of specifications can be different from the second set of specifications. As one non-exclusive example, as described in greater detail herein below, the first pitch 370A of the first rack teeth 138A can be substantially identical to the second pitch 370B of the second rack teeth 138B.

As illustrated in FIG. 1, the power supply 104 may be positioned in a rear corner of the first housing 102A adjacent to the storage media loader controller slot 106 and the library controller slot 108. The power supply 104 provides electrical power in a well known manner to the storage media loader controller slot 106, the library controller slot 108, the plurality of data transfer assembly slots 110A, 1108, and the storage media mover assembly 116, i.e. the mover motor 120. The power supply 104 is interfaced with these components as well as with an external power source in a well known manner using industry standard cabling and connections.

The first library segment 101A further includes a storage media loader controller 140 and a library controller 142. The storage media loader controller slot 106 receives the storage media loader controller 140, and the library controller slot 108 receives the library controller 142. In one embodiment, the storage media loader controller 140 can include a standard driver interface unit for receiving digital commands and translating the commands into driving currents, such as step pulses for controlling stepper motors. Further, the library controller 142 can include a standard programmable general purpose computer formed on a single plug-in card unit and preferably includes a programmed microprocessor or microcontroller according to the present invention, memory, communication interface, control interface, connectors, etc. In certain alternative embodiments, the first library segment 101A can be designed without the storage media loader controller slot 106 and/or without the library controller slot 108. In such embodiments, the storage media loader controller 140 and/or the library controller 142 can be part of or secured to the mover assembly 116.

The media library 100 can use well-known industry standard cabling and communication protocols between the storage media loader controller 140, the library controller 142 and/or the other components of the media library 100. Cabling and electrical characteristics including signaling protocols can be generally standardized, and the logical message protocols can be either proprietary or standardized as known to those skilled in the art. Alternatively, the media library 100 can be designed without the need for cabling.

Alternatively, the storage media loader controller 140 may be included as circuitry within or on the library controller card 142. The media library 100 may be operated by means of the storage media loader controller 140 and the library controller 142 for use in conventional data processing.

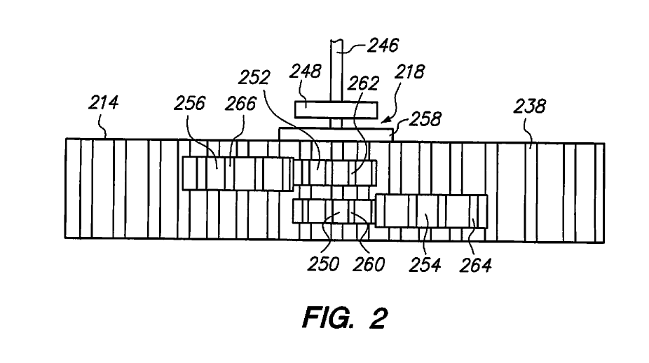

As provided above, the storage media mover assembly 116 includes the storage media mover 118 and the mover motor 120. The design of the storage media mover 118 can be varied depending upon the requirements of the media library 100. In one embodiment, as provided in detail herein below, the storage media mover 118 can include a drive shaft 246 (illustrated in FIG. 2), a drive gear 248 (illustrated in FIG. 2), a first pinion gear 250 (illustrated in FIG. 2), a second pinion gear 252 (illustrated in FIG. 2), a first rack gear 254 (illustrated in FIG. 2), a second rack gear 256 (illustrated in FIG. 2), and a differential adjuster 258 (illustrated in FIG. 2). It is recognized, however, that many different types of storage media movers 118 can be utilized as part of the storage media mover assembly 116 within the media library 100, and that the storage media mover 118 provided herein is merely representative of one such type and is not intended to limit the scope of the present invention in any manner.

In the embodiment illustrated in FIG. 1, the storage media mover 118 is positioned within the first housing 102A along the first rack 114A between the one or more first data transfer assembly slots 110A and the one or more storage media retainer slots 112A. Additionally, it should be noted that the storage media mover 118 is designed to move along and between the first rack 114A and the second rack 114B such that at any given time the storage media mover 118 can just as likely be positioned within the second housing 102B along the second rack 114B between the one or more second data transfer assembly slots 110B and the one or more second storage media retainer slots 1126. In this manner, the storage media mover 118 is able to load and unload storage media 134A, 134B to and from all of the data transfer devices 124A, 124B and the storage media retainers 130A, 130B within a given media library 100, i.e. within any of the library segments 101A, 101B within the media library 100.

The design of the mover motor 120 can be varied. For example, the mover motor 120 may comprise any controllably positionable electric motor such as a stepper motor, a servo motor, a linear motion device, or a DC motor. Alternatively, the mover motor 120 may have a different design.

During use, upon receiving a signal from the storage media loader controller 140 and/or the library controller 142 to access a certain storage media 134A, 1346, the mover motor 120 drives the storage media mover 118 so that it moves translationally along the first rack 114A and/or the second rack 114B to the appropriate position to access the requested storage media 134A, 134B. In particular, the storage media mover 118 is actuated in the directions indicated by arrows 144 by the mover motor 120 under the control of the storage media loader controller 140 and/or the library controller 142.

The storage media mover assembly 116 may further include a robotic mechanism (not illustrated), which upon direction from the storage media loader controller 140 and/or the library controller 142 physically retrieves an appropriate storage media 134A, 134B from its associated storage media slot 132A, 132B in the media library 100. Subsequently, the robotic mechanism moves the storage media 134A, 134B to an appropriate data transfer device 124A, 124B, i.e. an appropriate tape drive, and inserts the storage media 134A, 134B into the data transfer device 124A, 124B so that the requested read/write operations can be performed.

FIG. 2 is a simplified top view of a rack 214 and a portion of an embodiment of the storage media mover 218. The rack 214 can be the first rack 114A (illustrated in FIG. 1), the second rack 114B (illustrated in FIG. 1), or another rack.

As shown in FIG. 2, the rack 214 includes a plurality of rack teeth 238 that are positioned to engage a portion of the mover 218. Additionally, in this embodiment, the rack 214 extends in a straight linear direction. Alternatively, the rack 214, i.e. the first rack 114A, the second rack 114B, or other rack, can extend in other than a straight linear direction.

The design of the storage media mover 218 can vary. In the embodiment illustrated in FIG. 2, the mover 218 includes the drive shaft 246, the drive gear 248, the first pinion gear 250, the second pinion gear 252, the first rack gear 254, the second rack gear 256, and the differential adjuster 258. Alternatively, the mover 218 can have a different design. For example, in certain alternative embodiments, the mover 218 can be designed without the drive shaft 246 and/or without the drive gear 248.

As illustrated in FIG. 2, the drive shaft 246 is coupled to the drive gear 248 and moves the drive gear 248. In particular, rotation of the drive shaft 246, such as under the direction and control of the storage media loader controller 140 (illustrated in FIG. 1), the library controller 142 (illustrated in FIG. 1) and/or the mover motor 120 (illustrated in FIG. 1), results in a corresponding rotational movement of the drive gear 248. In one embodiment, the drive shaft 246 has a substantially circular shaped cross-section. Additionally, the drive shaft 246 can include a shaft end (not illustrated) that has a substantially non-circular shaped cross-section that fits within a substantially non-circular shaped gear aperture (not illustrated) in the center of the drive gear 248. Due to the non-circular shape of the shaft end and the gear aperture, rotation of the drive shaft 246 necessarily results in the corresponding rotation of the drive gear 248. Alternatively, the drive shaft 246 can have a different design and/or the drive shaft 246 can activate, i.e. rotate, the drive gear 248 in a different manner. Still alternatively, the mover 218 can be designed without the drive shaft 246, and the drive gear 248 can be rotated in a different manner. For example, in one non-exclusive alternative embodiment, the drive gear 248 can be activated by the rotation of one or more additional gears that engage the drive gear 248.

Additionally, in this embodiment, the drive gear 248 is fixedly coupled to the differential adjuster 258 such that rotation of the drive gear 248 results in a corresponding rotation of the differential adjuster 258. Stated another way, rotation of the drive shaft 246 results in the corresponding rotation of the drive gear 248, and, thus, the corresponding rotation of the differential adjuster 258. Alternatively, the mover 218 can be designed without the drive gear 248, and the drive shaft 246 can be directly coupled to the differential adjuster 258.

As illustrated in this embodiment, the first pinion gear 250 is mounted on the differential adjuster 258. In one embodiment, the first pinion gear 250 can be a spur gear including a plurality of first pinion teeth 260. Moreover, the first pinion gear 250 can be mounted on the differential adjuster 258 such that rotation (or non-rotation) of the differential adjuster 258 can, but does not necessarily, result in the corresponding rotation (or non-rotation) of the first pinion gear 250. In particular, the rotation of the differential adjuster 258 will result in the rotation of the first pinion gear 250 unless something is directly or indirectly inhibiting the rotation of the first pinion gear 250. Stated another way, the first pinion gear 250 can selectively rotate independently of and/or relative to the rotation of the differential adjuster 258. In certain, non-exclusive, alternative embodiments, the first pinion gear 250 can be a seven-tooth spur gear and have a diameter of approximately 13.5 millimeters, although other sizes and different numbers of teeth for the first pinion gear 250 can be utilized.

Additionally, the second pinion gear 252 is mounted on the differential adjuster 258. In one embodiment, the second pinion gear 252 can be a spur gear including a plurality of second pinion teeth 262. Moreover, the second pinion gear 252 can be mounted on the differential adjuster 258 such that rotation of the differential adjuster 258 can, but does not necessarily, result in the corresponding rotation of the second pinion gear 252. In particular, the rotation of the differential adjuster 258 will result in the rotation of the second pinion gear 252 unless forces and/or circumstances are directly or indirectly inhibiting the rotation of the second pinion gear 252. Stated another way, the second pinion gear 252 can selectively rotate independently of and/or relative to the rotation of the differential adjuster 258 and the first pinion gear 250. In certain, non-exclusive, alternative embodiments, the second pinion gear 252 can be a seven-tooth spur gear and have a diameter of approximately 13.5 millimeters, although other sizes and different numbers of teeth for the second pinion gear 252 can be utilized. Additionally, in some embodiments, the second pinion gear 252 can be approximately the same size as the first pinion gear 250. Alternatively, the first pinion gear 250 and the second pinion gear 252 can be different sizes.

As illustrated in FIG. 2, the first rack gear 254 is positioned to engage the first pinion gear 250 and the rack 214. More particularly, in one embodiment, the first rack gear 254 can be a spur gear including a plurality of first gear teeth 264 that are positioned to engage the first pinion teeth 260 and the rack teeth 238. Moreover, in certain embodiments, the diameter of the first rack gear 254 can be somewhat larger than that of the first pinion gear 250 such that when the first rack gear 254 engages the rack 214, the first pinion gear 250 does not also engage the rack 214. For example, in certain, non-exclusive, alternative embodiments, the first rack gear 254 can be an eight-tooth spur gear and have a diameter of approximately 15.0 millimeters, although other sizes and different numbers of teeth for the first rack gear 254 can be utilized. Additionally and/or alternatively, the first pinion gear 250 can be positioned somewhat farther away from the rack 214 than the first rack gear 254 such that when the first rack gear 254 engages the rack 214, the first pinion gear 250 does not also engage the rack 214.

Additionally, as illustrated, the second rack gear 256 is positioned to engage the second pinion gear 252 and the rack 214. More particularly, in one embodiment, the second rack gear 256 can be a spur gear including a plurality of second gear teeth 266 that are positioned to engage the second pinion teeth 262 and the rack teeth 238. Moreover, in certain embodiments, the diameter of the second rack gear 256 can be somewhat larger than that of the second pinion gear 252 such that when the second rack gear 256 engages the rack 214, the second pinion gear 252 does not also engage the rack 214. For example, in certain, non-exclusive, alternative embodiments, the second rack gear 256 can be an eight-tooth spur gear and have a diameter of approximately 15.0 millimeters, although other sizes and different numbers of teeth for the second rack gear 256 can be utilized. Additionally and/or alternatively, the second pinion gear 252 can be positioned somewhat farther away from the rack 214 than the second rack gear 256 such that when the second rack gear 256 engages the rack 214, the second pinion gear 252 does not also engage the rack 214.

Further, in some embodiments, the second rack gear 256 can be approximately the same size as the first rack gear 254. Alternatively, the first rack gear 254 and the second rack gear 256 can be different sizes.

The differential adjuster 258 is coupled to and extends between the drive gear 248 and the first pinion gear 250. Additionally, as noted above, the drive gear 248 is fixedly coupled to the differential adjuster 258, and the first pinion gear 250 and the second pinion gear 252 are each mounted on the differential adjuster 258. With this design, the first pinion gear 250 and the second pinion gear 252 can rotate together in unison, i.e. at the same time and at the same speed, and/or the first pinion gear 250 and the second pinion gear 252 can rotate independently of one another, i.e. at different times and/or at different speeds.

During use, upon receiving an appropriate signal from the storage media loader controller 140 and/or the library controller 142, the mover motor 120 drives the mover 218, i.e. rotates the drive shaft 246. Additionally, as noted above, rotation of the drive shaft 246 results in the corresponding rotation of the drive gear 248, and, thus, the corresponding rotation of the differential adjuster 258. Further, as noted above, absent forces and/or circumstances to directly or indirectly inhibit (or advance) rotation of the first pinion gear 250 and/or the second pinion gear 252, rotation of the differential adjuster 258 will result in the corresponding rotation of the first pinion gear 250 and the second pinion gear 252.

Still further, due to the relative positions of the first pinion gear 250 and the first rack gear 254, rotation of the first pinion gear 250 results in the first pinion teeth 260 engaging the first gear teeth 264, and, thus, results in the corresponding rotation of the first rack gear 254. Additionally, rotation of the first rack gear 254 results in the first gear teeth 264 engaging the rack teeth 238 so that the first rack gear 254, and thus the mover 218, can move translationally along the rack 214.

Somewhat similarly, due to the relative positions of the second pinion gear 252 and the second rack gear 256, rotation of the second pinion gear 252 results in the second pinion teeth 262 engaging the second gear teeth 266, and, thus, results in the corresponding rotation of the second rack gear 256. Additionally, rotation of the second rack gear 256 results in the second gear teeth 266, engaging the rack teeth 238 so that the second rack gear 256, and thus the mover 218, can move translationally along the rack 214. Accordingly, the engagement between one or both of the first gear teeth 264 and the second gear teeth 266 and the rack teeth 238 results in the mover 218 moving translationally along the rack 214.

In summary, the mounting of the first pinion gear 250 and the second pinion gear 252 on the differential adjuster 258 allows the storage media mover 218 to move smoothly in a translational direction along the rack 214 and along and between any adjacent racks. Further, this smooth movement of the mover 218 along the racks is possible despite certain differences in rack pitch between the racks and/or despite some misalignment between the racks. For example, the storage media mover 218 as described herein can move smoothly along and between the first rack 114A and the second rack 114B despite certain differences in rack pitch between the racks 114A, 114B and/or despite some misalignment between the racks 114A, 114B, and with little or no compromise to performance.

FIGS. 3A-3E are simplified front views of an embodiment of the first rack 314A, the second rack 314B, and a portion of the storage media mover 218 illustrated in FIG. 2, as the mover 218 moves gradually from the first rack 314A to the second rack 314B. As illustrated, the first rack 314A is substantially aligned with the second rack 314B, but the first rack 314A is spaced apart from the second rack 314B by a rack joint gap 368 (illustrated, for example, in FIG. 3B). For example, in certain, non-exclusive embodiments, the rack joint gap 368 can be approximately zero-2.0 millimeters. Alternatively, the rack joint gap 368 can be greater than 2.0 millimeters. Still alternatively, the first rack 314A can be somewhat misaligned relative to the second rack 314B without deviating from the teachings of the present invention.

Additionally, the first rack 314A includes first rack teeth 338A having a first pitch 370A. Further, the second rack 314B includes second rack teeth 338B having a second pitch 3706. In this embodiment, the first pitch 370A is substantially equal to the second pitch 370B. For example, in certain, non-exclusive embodiments, each of the first pitch 370A and the second pitch 3708 can be approximately 1.5 module, although other sizes for the first pitch 370A and/or the second pitch 370B can be utilized. Alternatively, the first rack 314A and the second rack 314B can be designed so that the first pitch 370A is different than the second pitch 370B. For example, the first pitch 370A can be a multiple of the second pitch 370B; the second pitch 370B can be a multiple of the first pitch 370A; or the first pitch 370A and the second pitch 370B can have a different numerical relationship to one another.

In particular, FIG. 3A illustrates the first rack 314A, the second rack 3146 and the mover 218, wherein the first rack gear 254 and the second rack gear 256 of the mover 218 are both positioned adjacent to the first rack 314A as the mover 218 moves along the first rack 314A. In this situation, there are no forces and/or circumstances that inhibit (or advance) the rotation of the first pinion gear 250 and/or the second pinion gear 252. Thus, the rotation of the adjuster mechanism 258 (illustrated in FIG. 2) results in the corresponding rotation of the first pinion gear 250 and the second pinion gear 252. Moreover, the first pinion gear 250 and the second pinion gear 252 will rotate at the same time and at the same speed, i.e. the first pinion gear 250 and the second pinion gear 252 will not rotate independently of one another.

It should be noted that a portion of the first pinion gear 250 has been removed in FIG. 3A in order to more clearly illustrate the engagement between the second pinion gear 252 and the second rack gear 256.

Additionally, the rotation of the first pinion gear 250 and the second pinion gear 252 will result in the corresponding rotation of the first rack gear 254 and the second rack gear 256, respectively. Since the first rack gear 254 engages and thus rotates at the same time and the same speed as the first pinion gear 250, and since the second rack gear 256 engages and thus rotates at the same time and same speed as the second pinion gear 252, the first rack gear 254 is necessarily rotating at the same time and the same speed as the second rack gear 256. Stated another way, in this situation, the first rack gear 254 and the second rack gear 256 are not rotating independently of one another. Further, when the first rack gear 254 is positioned adjacent to and is rotating relative to the first rack 314A, the first gear teeth 264 engage the first rack teeth 338A and the first rack gear 254, and thus the mover 218, moves translationally along the first rack 314A. Similarly, when the second rack gear 256 is positioned adjacent to and is rotating relative to the first rack 314A, the second gear teeth 266 engage the first rack teeth 338A and the second rack gear 256, and thus the mover 218, moves translationally along the first rack 314A.

Additionally, FIG. 3B illustrates the first rack 314A, the second rack 314B and mover 218, wherein the first rack gear 254 is positioned adjacent to the rack joint gap 368 and the second rack gear 256 is positioned adjacent to the first rack 314A as the mover 218 moves along the first rack 314A and between the first rack 314A and the second rack 314B. In this situation, the rack joint gap 368 effectively creates or defines a joint pitch 370J, wherein the first rack gear 254 is rotating relative to the joint pitch 370J and the second rack gear 256 is rotating relative to the first pitch 370A of the first rack 314A. As utilized herein, the term “joint pitch” means the distance from a position on the last first rack tooth 338A to the corresponding position on the first second rack tooth 338B. Further, the joint pitch 370J is different than the first pitch 370A. Moreover, if the joint pitch 370J is not a precise multiple of the first pitch 370A, then as the first gear teeth 364 approach the second rack teeth 338B there will not be a precise alignment as the first gear teeth 364 begin to rotate relative to and adjacent to the second rack teeth 338B. This absence of precise alignment will need to be compensated for and thus creates a force and/or circumstance that inhibits (or advances) rotation of the first pinion gear 250. Thus, the rotation of the adjuster mechanism 258 (illustrated in FIG. 2) will not result in the first pinion gear 250 and the second pinion gear 252 rotating at the same time and at the same speed, i.e. the first pinion gear 250 and the second pinion gear 252 will be rotating at different times and/or at different speeds. Stated another way, the force and/or circumstance that inhibits (or advances) rotation of the first pinion gear 250 relative to the adjuster mechanism 258 will result in the first pinion gear 250 rotating independently of the second pinion gear 252.

It should be noted that a portion of the first pinion gear 250 has been removed in FIG. 3B in order to more clearly illustrate the engagement between the second pinion gear 252 and the second rack gear 256.

Further, the rotation of the first pinion gear 250 and the second pinion gear 252 will result in the corresponding rotation of the first rack gear 254 and the second rack gear 256, respectively. Since the first rack gear 254 engages and thus rotates at the same time and the same speed as the first pinion gear 250, and since the second rack gear 256 engages and thus rotates at the same time and same speed as the second pinion gear 252, the first rack gear 254 is necessarily rotating at a different time and/or at a different speed than the second rack gear 256. Stated another way, in this situation, the first rack gear 254 and the second rack gear 256 are rotating independently of one another, although the first rack gear 254 and the second rack gear 256 are interconnected through the differential adjuster 258.

In addition, FIG. 3C illustrates the first rack 314A, the second rack 314B and the mover 218, wherein the first rack gear 254 is positioned adjacent to the second rack 314B and the second rack gear 256 is positioned adjacent to the first rack 314A as the mover 218 moves along the first rack 314A and along the second rack 314B. In this situation, the first rack gear 254 is rotating relative to the second pitch 3706 of the second rack 314B and the second rack gear 256 is rotating relative to the first pitch 370A of the first rack 314A. As noted above, in this embodiment, the first pitch 370A is substantially equal to the second pitch 370B. Thus, there are no forces and/or circumstances that inhibit (or advance) the rotation of the first pinion gear 250 and/or the second pinion gear 252. It should be noted that a portion of the first pinion gear 250 has been removed in FIG. 3C in order to more clearly illustrate the engagement between the second pinion gear 252 and the second rack gear 256.

Additionally, the rotation of the adjuster mechanism 258 (illustrated in FIG. 2) results in the corresponding rotation of the first pinion gear 250 and the second pinion gear 252. Moreover, the first pinion gear 250 and the second pinion gear 252 will rotate at the same time and at the same speed, i.e. the first pinion gear 250 and the second pinion gear 252 will not rotate independently of one another. In alternative embodiments, if the first pitch 370A is not substantially equal to the second pitch 370B, then a force and/or circumstance may exist that inhibits (or advances) the rotation of the first pinion gear 250 and/or the second pinion gear 252. In such embodiment, the adjuster mechanism 258 will enable the first pinion gear 250 and the second pinion gear 252, to the extent necessary, rotate independently of one another.

Additionally, the rotation of the first pinion gear 250 and the second pinion gear 252 will result in the corresponding rotation of the first rack gear 254 and the second rack gear 256, respectively. Since the first rack gear 254 engages and thus rotates at the same time and the same speed as the first pinion gear 250, and since the second rack gear 256 engages and thus rotates at the same time and same speed as the second pinion gear 252, the first rack gear 254 is necessarily rotating at the same time and the same speed as the second rack gear 256. Stated another way, in this situation, the first rack gear 254 and the second rack gear 256 are not rotating independently of one another. Further, when the first rack gear 254 is positioned adjacent to and is rotating relative to the second rack 314B, the first gear teeth 264 engage the second rack teeth 338B and the first rack gear 254, and thus the mover 218, moves translationally along the second rack 3146. Somewhat similarly, when the second rack gear 256 is positioned adjacent to and is rotating relative to the first rack 314A, the second gear teeth 266 engage the first rack teeth 338A and the second rack gear 256, and thus the mover 218, moves translationally along the first rack 314A.

Still further, FIG. 3D illustrates the first rack 314A, the second rack 314B and the mover 218, wherein the first rack gear 254 is positioned adjacent to the second rack 314B and the second rack gear 256 is positioned adjacent to the rack joint gap 368 as the mover 218 moves along the second rack 314B and between the first rack 314A and the second rack 314B. In this situation, the first rack gear 254 is rotating relative to the second pitch 3706 of the second rack 314B and the second rack gear 256 is rotating relative to the joint pitch 370J of the rack joint gap 368. Further, as above, the joint pitch 370J is different than the second pitch 370B. Moreover, if the joint pitch 370J is not a precise multiple of the second pitch 3706, then as the second gear teeth 366 approach the second rack teeth 3386 there will not be a precise alignment as the second gear teeth 366 begin to rotate relative to and adjacent to the second rack teeth 338B. This absence of precise alignment will need to be compensated for and thus creates a force and/or circumstance that inhibits (or advances) rotation of the second pinion gear 252. Thus, the rotation of the adjuster mechanism 258 (illustrated in FIG. 2) will not result in the first pinion gear 250 and the second pinion gear 252 rotating at the same time and at the same speed, i.e. the first pinion gear 250 and the second pinion gear 252 will be rotating at different times and/or at different speeds. Stated another way, the force and/or circumstance that inhibits (or advances) rotation of the second pinion gear 252 relative to the adjuster mechanism 258 will result in the second pinion gear 252 rotating independently of the first pinion gear 250.

It should be noted that a portion of the first pinion gear 250 has been removed in FIG. 3D in order to more clearly illustrate the engagement between the second pinion gear 252 and the second rack gear 256.

Further, the rotation of the first pinion gear 250 and the second pinion gear 252 will result in the corresponding rotation of the first rack gear 254 and the second rack gear 256, respectively. Since the first rack gear 254 engages and thus rotates at the same time and the same speed as the first pinion gear 250, and since the second rack gear 256 engages and thus rotates at the same time and same speed as the second pinion gear 252, the first rack gear 254 is necessarily rotating at a different time and/or at a different speed than the second rack gear 256. Stated another way, in this situation, the first rack gear 254 and the second rack gear 256 are rotating independently of one another.

Yet further, FIG. 3E illustrates the first rack 314A, the second rack 314B and the mover 218, wherein the first rack gear 254 and the second rack gear 256 are both positioned adjacent to the second rack 314B as the mover 218 moves along the second rack 314B. In this situation, there are no forces and/or circumstances that inhibit (or advance) the rotation of the first pinion gear 250 and/or the second pinion gear 252. Thus, the rotation of the adjuster mechanism 258 (illustrated in FIG. 2) results in the corresponding rotation of the first pinion gear 250 and the second pinion gear 252. Moreover, the first pinion gear 250 and the second pinion gear 252 will rotate at the same time and at the same speed, i.e. the first pinion gear 250 and the second pinion gear 252 will not rotate independently of one another.

It should be noted that a portion of the first pinion gear 250 has been removed in FIG. 3E in order to more clearly illustrate the engagement between the second pinion gear 252 and the second rack gear 256.

Additionally, the rotation of the first pinion gear 250 and the second pinion gear 252 will result in the corresponding rotation of the first rack gear 254 and the second rack gear 256, respectively. Since the first rack gear 254 engages and thus rotates at the same time and the same speed as the first pinion gear 250, and since the second rack gear 256 engages and thus rotates at the same time and same speed as the second pinion gear 252, the first rack gear 254 is necessarily rotating at the same time and the same speed as the second rack gear 256. Stated another way, in this situation, the first rack gear 254 and the second rack gear 256 are not rotating independently of one another. Further, when the first rack gear 254 is positioned adjacent to and is rotating relative to the second rack 314B, the first gear teeth 264 engage the second rack teeth 338B and the first rack gear 254, and thus the mover 218, moves translationally along the second rack 314B. Similarly, when the second rack gear 256 is positioned adjacent to and is rotating relative to the second rack 314B, the second gear teeth 266 engage the second rack teeth 338B and the second rack gear 256, and thus the mover 218, moves translationally along the second rack 314B.

While a number of exemplary aspects and embodiments of a media library 100 have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A combination comprising:
a first rack;
a second rack positioned substantially adjacent to the first rack; and
a mover including (i) a first rack gear that moves along and between the first rack and the second rack, (ii) a second rack gear that moves along and between the first rack and the second rack, and (iii) a differential adjuster that is coupled to the first rack gear and the second rack gear, the differential adjuster enabling the first rack gear and the second rack gear to selectively rotate independently of one another.

2. The combination of claim 1 wherein the first rack has a plurality of first rack teeth and the second rack has a plurality of second rack teeth, the rack gears each engaging the first rack teeth and the second rack teeth.

3. The combination of claim 1 wherein the first rack is spaced apart from the second rack by a rack joint gap, and wherein while one of the rack gears is positioned adjacent to the rack joint gap, the first rack gear and the second rack gear can rotate independently of one another.

4. The combination of claim 3 wherein the first rack includes a plurality of first rack teeth and the second rack includes a plurality of second rack teeth, the first rack teeth having a first pitch and the rack joint gap defining a joint pitch that is different than the first pitch.

5. The combination of claim 4 wherein the second rack teeth have a second pitch, and wherein the joint pitch is different than the second pitch.

6. The combination of claim 4 wherein the second rack teeth have a second pitch that is substantially equal to the first pitch.

7. The combination of claim 6 wherein when the first rack gear moves along the first rack and the second rack gear moves the second rack, the first rack gear rotates at a first speed and the second rack gear rotates at a second speed that is substantially equal to the first speed.

8. The combination of claim 1 wherein the mover further includes (i) a first pinion gear that is mounted on the differential adjuster, the first pinion gear being positioned to engage the first rack gear, and (ii) a second pinion gear that is mounted on the differential adjuster, the second pinion gear being positioned to engage the second rack gear; and wherein the differential adjuster enables the first pinion gear and the second pinion gear to selectively rotate independently of one another.

9. The combination of claim 8 wherein the mover further includes a drive shaft that is coupled to the differential adjuster, the drive shaft moving the differential adjuster and the pinion gears such that the pinion gears rotate at substantially the same speed.

10. The combination of claim 8 wherein the mover further includes a drive shaft that is coupled to the differential adjuster, the drive shaft moving the differential adjuster and the pinion gears such that the pinion gears rotate at different speeds.

11. The combination of claim 8 further comprising a mover motor that rotates the pinion gears to move the mover along and between the first rack and the second rack.

12. A media library including a first library housing, a second library housing that is positioned substantially adjacent to the first library housing, and the combination of claim 1, wherein the first rack is positioned within the first library housing and the second rack is positioned within the second library housing.

13. The media library of claim 12 further including a tape cartridge, the mover moving the tape cartridge between the first library housing and the second library housing.

14. A mover for use with a first rack and a second rack, the first rack including a plurality of first rack teeth having a first pitch, the second rack including a plurality of second rack teeth having a second pitch, and the first rack being spaced apart from the second rack by a rack joint gap that defines a joint pitch that is different than the first pitch and the second pitch, the mover comprising:
a first rack gear that moves along and between the first rack and the second rack;
a second rack gear that moves along and between the first rack and the second rack; and
a differential adjuster that is coupled to the first rack gear and the second rack gear, the differential adjuster enabling the first rack gear and the second rack gear to selectively rotate independently of one another.

15. The mover of claim 14 wherein while one of the rack gears is positioned adjacent to the rack joint gap the first rack gear and the second rack gear can rotate independently of one another.

16. The mover of claim 14 wherein when the first rack gear moves along the first rack and the second rack gear moves the second rack, the first rack gear rotates at a first speed and the second rack gear rotates at a second speed that is substantially equal to the first speed.

17. The mover of claim 14 further comprising (i) a first pinion gear that is mounted on the differential adjuster, the first pinion gear being positioned to engage the first rack gear, and (ii) a second pinion gear that is mounted on the differential adjuster, the second pinion gear being positioned to engage the second rack gear; wherein the differential adjuster enables the first pinion gear and the second pinion gear to selectively rotate independently of one another.

18. The mover of claim 17 further comprising a drive shaft that is coupled to the differential adjuster, the drive shaft moving the differential adjuster and the pinion gears such that the pinion gears rotate at substantially the same speed.

19. The mover of claim 17 further comprising a drive shaft that is coupled to the differential adjuster, the drive shaft moving the differential adjuster and the pinion gears such that the pinion gears rotate at different speeds.

20. A mover for use with a first rack and a second rack, the first rack including a plurality of first rack teeth having a first pitch, the second rack including a plurality of second rack teeth having a second pitch, and the first rack being spaced apart from the second rack by a rack joint gap that defines a joint pitch that is different than the first pitch and the second pitch, the mover comprising:
a first rack gear that moves along and between the first rack and the second rack;
a first pinion gear that engages the first rack gear;
a second rack gear that moves along and between the first rack and the second rack;
a second pinion gear that engages the second rack gear;
a differential adjuster that enables the first rack gear and the second rack gear to selectively rotate independently of one another, the differential adjuster supporting the first pinion gear and the second pinion gear; and
a drive shaft that is coupled to and moves the differential adjuster;
wherein while one of the rack gears is positioned adjacent to the rack joint gap, the first rack gear and the second rack gear can rotate independently of one another.

21. A combination comprising the first rack, the second rack, and the mover of claim 20.

22. A media library including a first library housing, a second library housing that is positioned substantially adjacent to the first library housing, and the combination of claim 21, wherein the first rack is positioned within the first library housing and the second rack is positioned within the second library housing.
